(19) United States
(12) Patent Application Publication
(10) Pub. No.: US 2011/0145725 A1
(43) Pub. Date: Jun. 16, 2011

(54) Methods and Systems for Attaching Semantics to a Collaborative Writing Surface

(76) Inventors: Richard John Campbell, Camas, WA (US); Ahmet Mufit Ferman, Vancouver, WA (US); Lawrence Shao-hsien Chen, Vancouver, WA (US)

(21) Appl. No.: 12/636,533

(22) Filed: Dec. 11, 2009

(51) Int. Cl. G06F 3/00

(52) U.S. Cl. 715/751

(57) ABSTRACT

Aspects of the present invention are related to systems and methods for detection of content change on a collaborative writing surface and for associating semantic meaning with a detected marking in a reserved region of the collaborative writing surface.

### FIELD OF THE INVENTION

Embodiments of the present invention relate generally to collaboration systems and, in particular, to methods and systems for extending the functionality of a collaborative writing surface through semantic attachment.

### BACKGROUND

Flipcharts, whiteboards, chalkboards and other physical writing surfaces may be used to facilitate a creative interaction between peers. Methods and systems for capturing the information on these surfaces, referred to as collaborative writing surfaces, without hindering the creative interaction; allowing the captured information to be shared seamlessly and naturally between non-co-located parties; and generating a record of the interaction that may be subsequently accessed and replayed may be desirable. In addition to capturing marks on the collaborative writing surface, it may be desirable to attach semantic meaning to particular markings detected on the collaborative writing surface.

### SUMMARY

Some embodiments of the present invention comprise methods and systems for extending the functionality of a collaborative writing surface through semantic attachment.

According to one aspect of the present invention, a change detected between a reference frame associated with a collaborative writing surface and a current frame associated with the collaborative writing surface may be identified as a semantic marking when the marking is determined to be located in a semantic-significant region of the collaborative writing surface.

Accordingly a process may be initiated based on a semantic meaning associated with the detected semantic marking.

In some embodiments of the present invention, the process may be associated with updating a writing-surface record, corresponding to the collaborative writing surface, in accordance with an attribute associated with the semantic marking.

In some embodiments of the present invention, the process may relate to an action associated with the semantic marking. Exemplary actions may include the tagging, in the writing-surface record, of a region of the collaborative writing surface with a metadata tag, the attachment of a routing schedule to a region of the collaborative writing surface recorded in the writing-surface record, the initiation of a post-processing process on the writing-surface record, for example, optical character recognition or content summarization, in conjunction with a region of the collaborative writing surface and other actions.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture depicting an exemplary collaboration system comprising a collaborative writing surface, an image acquisition system, a computing system and a communication link between the image acquisition system and the computing system;

FIG. 2 is a picture depicting an exemplary camera-view image of a exemplary collaborative writing surface and a rectified image showing an exemplary view of the collaborative writing surface after the removal of perspective distortion introduced by an off-axis placement of the camera relative to the collaborative writing surface;

FIG. 3 is a chart showing exemplary embodiments of the present invention comprising update of a reference frame associated with a collaborative writing surface after the detection of an occlusion/dis-occlusion event pair;

FIG. 4 is a picture of a finite state machine corresponding to exemplary embodiments of the present invention comprising update of a reference frame associated with a collaborative writing surface after the detection of an occlusion/dis-occlusion event pair;

FIG. 5 is a picture depicting an exemplary group of blocks associated with a difference image, and according to embodiments of the present invention: the white blocks represent blocks in which there was not a sufficient number of mask pixels exceeding the difference threshold to mark the block as a “changed” block; the four groupings of non-white pixels indicate “changed” blocks, of which the darkest blocks may not be considered an occluding object because this group of contiguous blocks is not connected to a frame boundary, the hatched blocks may be considered likely occluding objects, but may not trigger an occlusion event because their size is below a size threshold and the gray object may be considered an occluding object, based on its size and proximity to a frame boundary, and may trigger an occlusion event;

FIG. 6 is a chart showing exemplary embodiments of the present invention comprising occlusion detection and dis-occlusion detection;

FIG. 7 is a chart showing exemplary embodiments of the present invention comprising actor identification;

FIG. 8 is a picture of a finite state machine corresponding to exemplary embodiments of the present invention comprising actor identification;

FIG. 9 is a chart showing exemplary embodiments of the present invention comprising updating a reference image based on the detection of an occlusion/dis-occlusion event pair;

FIG. 10 is a chart showing exemplary embodiments of the present invention comprising updating a reference image based on the detection of an occlusion/dis-occlusion event pair and maintaining a collaboration script;

FIG. 11 is a chart showing exemplary embodiments of the present invention comprising updating a reference image and an actor identification tag based on the detection of an occlusion/dis-occlusion event pair;

FIG. 12 is a chart showing exemplary embodiments of the present invention comprising updating a reference image and an actor identification tag based on the detection of an occlusion/dis-occlusion event pair and maintaining a collaboration script; and

FIG. 13 is a chart showing exemplary embodiments of the present invention comprising detecting semantic markings and updating a writing-surface record in accordance with the detected semantic markings;

FIG. 14 is a picture depicting exemplary semantic-significant regions of a collaborative writing surface;

FIG. 15A is a picture depicting an exemplary collaborative writing surface, at a first time;

FIG. 15B is a picture depicting the exemplary collaborative writing surface from FIG. 15A, at a subsequent time, showing a semantic marking;

FIG. 16 is a picture depicting the changes, according to embodiments of the present invention, between the exemplary collaborative writing surface shown in FIG. 15A and the exemplary collaborative writing surface shown in FIG. 15B;

FIG. 17A is a picture depicting the writing-surface record, according to embodiments of the present invention, corresponding to the exemplary collaborative writing surface shown in FIG. 15A;

FIG. 17B is a picture depicting the writing-surface record, according to embodiments of the present invention, corresponding to the exemplary collaborative writing surface shown in FIG. 15B;

FIG. 18A is a picture depicting the reference frame, according to embodiments of the present invention, corresponding to FIG. 15A and FIG. 17A;

FIG. 18B is a picture depicting the reference frame, according to embodiments of the present invention, corresponding to FIG. 15B and FIG. 17B;

FIG. 19A is a picture depicting an exemplary collaborative writing surface;

FIG. 19B is a picture depicting an exemplary collaborative writing surface containing an indicator marking;

FIG. 20A is a picture depicting the writing-surface record, according to embodiments of the present invention, corresponding to the exemplary collaborative writing surface shown in FIG. 19A;

FIG. 20B is a picture depicting the writing-surface record, according to embodiments of the present invention, corresponding to the exemplary collaborative writing surface shown in FIG. 19B;

FIG. 21A is a picture depicting an exemplary collaborative writing surface containing an indicator marking;

FIG. 21B is a picture depicting the writing-surface record, according to embodiments of the present invention, corresponding to the exemplary collaborative writing surface shown in FIG. 21A;

FIG. 22A is a picture depicting an exemplary collaborative writing surface containing an indicator marking;

FIG. 22B is a picture depicting the writing-surface record, according to embodiments of the present invention, corresponding to the exemplary collaborative writing surface shown in FIG. 22A;

FIG. 23 is a chart showing exemplary embodiments of the present invention comprising detection of semantic markings; and

FIG. 24 is a picture showing exemplary embodiments of the present invention comprising a semantic-marking detector and a semantic-marking interpreter.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention, but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Flipcharts, whiteboards, chalkboards and other physical writing surfaces may be used to facilitate a creative interaction between peers. Methods and systems for capturing the information on these surfaces, referred to as collaborative writing surfaces, without hindering the creative interaction; allowing the captured information to be shared seamlessly and naturally between non-co-located parties; and generating a record of the interaction that may be subsequently accessed and replayed may be desirable. In addition to capturing marks on the collaborative writing surface, it may be desirable to attach semantic meaning to particular markings detected on the collaborative writing surface.

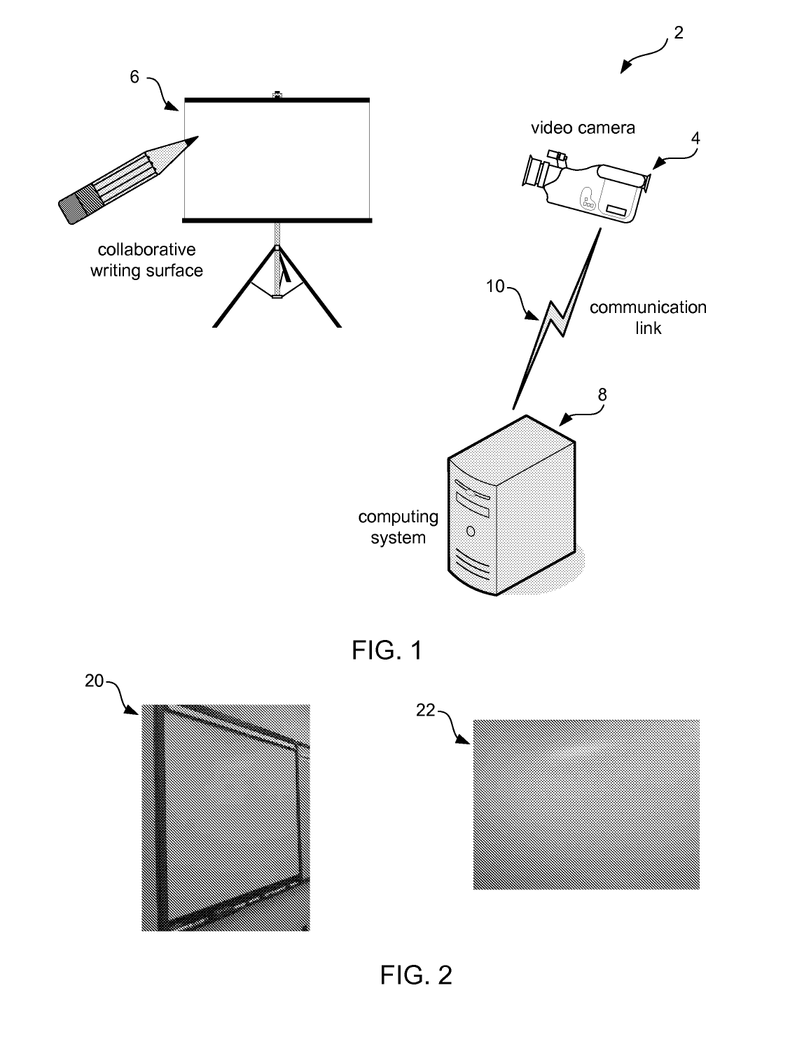

Embodiments of the present invention comprise methods and systems for capturing, sharing and recording the information on a collaborative writing surface. Exemplary collaborative writing surfaces may include a flipchart, a whiteboard, a chalkboard, a piece of paper and other physical writing surfaces. Some embodiments of the present invention may comprise a collaboration system 2 that may be described in relation to FIG. 1. The collaboration system 2 may comprise a video camera, or other image acquisition system, 4 that is trained on a collaborative writing surface 6. In some embodiments of the present invention, color image data may be acquired by the video camera 4. In alternative embodiments, the video camera 4 may acquire black-and-white image data. The video camera 4 may be communicatively coupled to a host computing system 8. Exemplary host computing systems 8 may comprise a single computing device or a plurality of computing devices. In some embodiments of the present invention, wherein the host computing system 8 comprises a plurality of computing devices, the computing devices may be co-located. In alternative embodiments of the present invention, wherein the host computing system 8 comprises a plurality of computing devices, the computing devices may not be co-located.

The connection 10 between the video camera 4 and the host computing system 8 may be any wired or wireless communications link.

In some embodiments of the present invention, the video camera 4 may be placed at an off-axis viewpoint that is non-perpendicular to the collaborative writing surface 6 to provide a minimally obstructed view of the collaborative writing surface 6 to local collaboration participants.

The video camera 4 may obtain image data associated with the collaborative writing surface 6. In some embodiments, the image data may be processed, in part, by a processor on the video camera 4 and, in part, by the host computing system 8. In alternative embodiments, the image data may be processed, in whole, by the host computing system 8.

In some embodiments of the present invention, raw sensor data obtained by the video camera 4 may be demosaiced and rendered. Demosaicing may reconstruct coincident three-color output data from non-coincident samples obtained by a camera filter array. Exemplary embodiments of the present invention may comprise a Bayer filter array in the video camera 4 and may comprise methods and systems known in the art for demosaicing color data obtained from a Bayer filter array. Alternative demosaicing methods and systems known in the art may be used when the digital camera 4 sensor array is a non-Bayer filter array.

In some embodiments of the present invention, the collaboration system 2 may comprise an image rectifier to eliminate, in the rendered image data, perspective distortion introduced by the relative position of the video camera 4 and the collaborative writing surface 6. FIG. 2 depicts an exemplary camera-view image 20 and the associated image 22 after geometric transformation to eliminate perspective distortion.

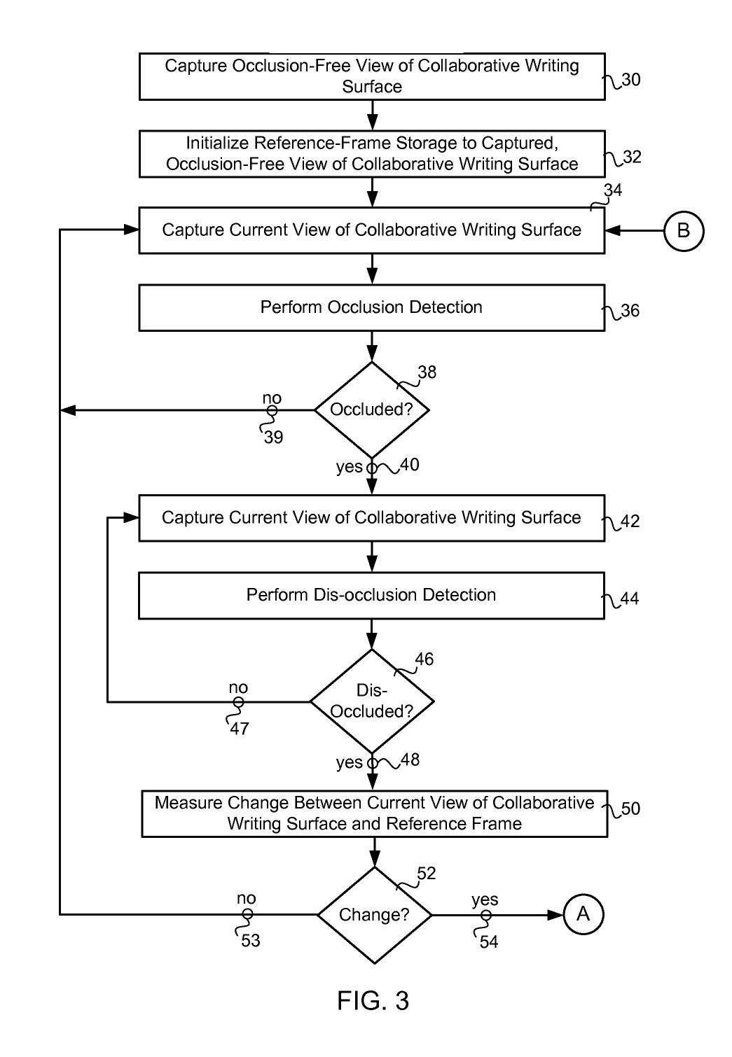

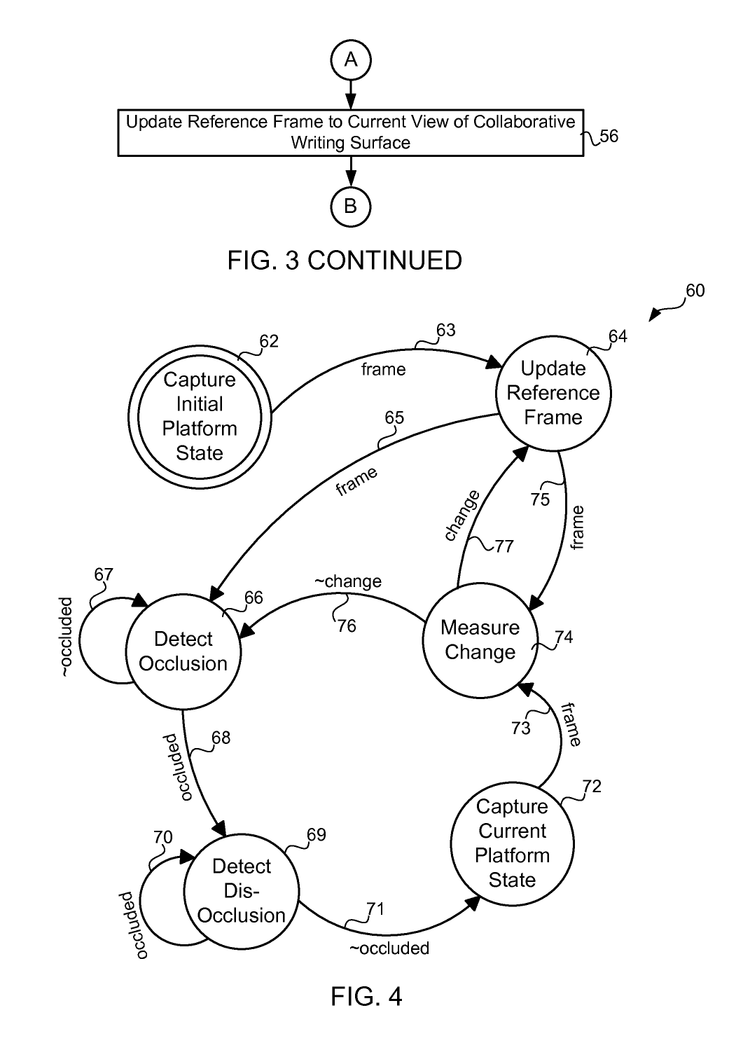

Some embodiments of the present invention may be described in relation to FIG. 3. In these embodiments, an occlusion-free view of a collaborative writing surface may be captured 30. A memory, buffer or other storage associated with a reference frame, also considered a reference image, may be initialized 32 to the captured, occlusion-free view of the collaborative writing surface. A current view of the collaborative writing surface may be captured 34, and occlusion detection may be performed 36. The captured current view of the collaborative writing surface may be referred to as the current frame, or current image. If no occluding event is detected 39, then the current-view capture 34 and occlusion detection 36 may continue. If an occluding event is detected 40, a current view of the collaborative writing surface may be captured 42 and dis-occlusion detection 44 may be performed. While the current view remains occluded 47, the current-view capture 42 and dis-occlusion detection 44 may continue. When the current view is determined 46 to be dis-occluded 48, then the change between the current frame and the reference frame may be measured 50. If there is no measured change 53, then the current-view capture 34 and occlusion detection 36 continue. If there is a measured change 54, then the reference frame may be updated 56 to the current frame by writing the current frame data to the memory, buffer or other storage associated with the reference frame. The current-view capture 34 and occlusion detection 36 may then continue.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

Some embodiments of the present invention may be understood in relation to a finite state machine (FSM) diagram 60 shown in FIG. 4. Some embodiments of the present invention may comprise the finite state machine 60 embodied in hardware. Alternative embodiments of the present invention may comprise the finite state machine 60 embodied in a computer-program product that is a computer-readable storage medium, and/or media, having instructions stored thereon, and/or therein, that may be used to program a computer to perform the features of the finite state machine 60. Still alternative embodiments may comprise the finite state machine 60 embodied in a combination of hardware and a computer-program product that is a computer-readable storage medium, and/or media, having instructions stored thereon, and/or therein, that may be used to program a computer to perform the features of the finite state machine 60.

An initial platform state may be captured 62, and the capture may trigger a transition 63 to an “update-reference-frame” state 64, in which an image frame associated with the initial capture may be used to initialize a reference frame, also referred to as a reference image, associated with the collaboration system. In some embodiments of the present invention, the initial platform state may be associated with an unobstructed view of the collaborative writing surface. The updating of the reference frame may trigger 65, 75 a state transition to a “detect-occlusion” state 66, in which it may be determined whether or not the view of the collaborative writing surface is obstructed, and a “measure-change” state 74, in which the change between an image associated with the current platform state and the reference image may be measured. If there is no occlusion detected, the collaboration system may remain 67 in the “detect-occlusion” state 66. If there is occlusion detected, the system may transition 68 to a “detect-dis-occlusion” state 69, in which it may be determined whether or not the view of collaborative writing surface is unobstructed. If there is no dis-occlusion detected, the system may remain 70 in the “detect-dis-occlusion” state 69. If there is dis-occlusion detected, the system may transition 71 to a “capture-current-platform” state 72, in which the current state of the platform may be captured. The capture of the dis-occluded frame may trigger a transition 73 to the “measure-change” state 74. If there is no measured change between the current frame and the reference frame, the system may transition 76 to the “detect-occlusion” state 66. If there is measurable change, then the system may transition 77 to the “update-reference-frame” state 64, in which the reference image may be updated to the captured dis-occluded frame. Updating the reference frame may trigger the transition 75 to the “measure-change” state 74.

In some embodiments of the present invention, occlusion detection may comprise comparing a current frame to a reference frame that is known to be occlusion free. The reference frame may be initialized when the collaborative-writing system is first initiated and subsequently updated, after an occlusion/dis-occlusion event pair.

In an exemplary embodiment, the difference between the luminance component of the reference frame, also referred to as the key frame, and the luminance component of the current frame may be determined according to:

f_{diff}L_{key}−L_{curr},

where f_{diff}, L_{key} and L_{curr} may denote the luminance difference, the luminance component of the reference frame and the luminance component of the current frame, respectively. In some embodiments, a luminance component may be computed for an RGB (Red-Green-Blue) image according to:

L_{(·)}=0.375R_{(·)}+0.5G_{(·)}+0.125B_{·)},

where L_{(·)}, R_{(·)}, G_{(·)} and B_{(·)} may denoted the luminance, red, green and blue components of a frame, respectively. In alternative embodiments, a luminance component may be computed for an RGB image according:

L_{(·)}=0.3R_{(·)}+0.6G_{(·)}+0.1B_{(·)}.

For a collaborative writing surface with a light background color, for example, a whiteboard or a flipchart, an occluding object may appear darker than the writing surface. If a collaborative writing surface has a darker background color, then an occluding object may appear lighter than the writing surface. The background color of the collaborative writing surface may be determined at system initialization. The following exemplary embodiments will be described for a collaborative writing surface with a light-colored background. This is for illustrative purposes and is not a limitation.

In exemplary embodiments comprising a collaborative writing surface with a light-colored background, negative-valued f_{diff} pixels may correspond to locations where the current frame appears brighter than the reference frame, and these pixels may be ignored in occlusion detection. Additionally, the difference signal, f_{diff}, may contain spurious content due to noise in the imaging system, variations in the lighting conditions and other factors. The magnitude of the difference signal, f_{diff}, at a pixel location may denote the significance of a change at that position. Hence, small positive values in f_{diff} may also be eliminated for further processing in the occlusion-detection stage. In some embodiments, the pixel values of f_{diff} may be compared to a difference threshold, which may be denoted T_{occ}, to determine which pixel locations may be associated with likely occlusion. A binary mask of the locations may be formed according to:

$${m}_{diff} ( i , j ) = \{ \begin{matrix}1 , & {f}_{diff} ( i , j ) > {T}_{occ} \\ 0 , & otherwise ,\end{matrix}$$

where m_{diff} may denote the mask and (i, j) may denote a pixel location.

The mask m_{diff} may be divided into non-overlapping blocks, and the number of pixels in each block that exceed the difference threshold, T_{occ}, may be counted. If the count for a block exceeds a block-density threshold, which may be denoted T_{bden}, then the block maybe marked as a “changed” block. Contiguous “changed” blocks that are connected to a frame boundary may be collectively labeled as an occluding object. “Changed” blocks that do not abut a frame boundary may represent noise or content change, and these “changed” blocks may be ignored. An occlusion event may be declared if the size of an occluding object exceeds a size threshold, which may be denoted T_{objsize}.

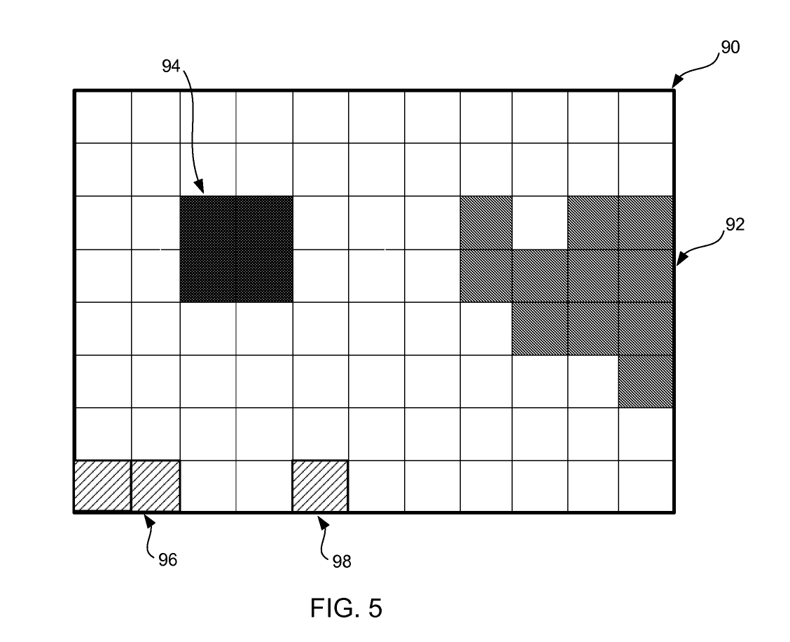

FIG. 5 depicts an exemplary group of blocks 90 associated with a difference image. The white blocks represent blocks in which there was not a sufficient number of mask pixels exceeding the difference threshold to mark the block as a “changed” block. The four groupings 92, 94, 96, 98 of non-white pixels indicate “changed” blocks. The darkest blocks 94 may not be considered an occluding object because this group of contiguous blocks is not connected to a frame boundary. The hatched blocks 96, 98 may be considered likely occluding objects, but may not trigger an occlusion event because their size is below a size threshold. The gray object 92 may be considered an occluding object, based on its size and proximity to a frame boundary, and may trigger an occlusion event.

In an exemplary embodiment of the present invention, the size of a block may be 80 pixels by 80 pixels.

In an exemplary embodiment of the present invention comprising 8-bit luminance values, the difference threshold, T_{occ}, may be 15.

In an exemplary embodiment of the present invention, the block-density threshold, T_{bden}, may be 50 percent of the number of pixels in the block. In these embodiments, a block may be labeled as a “changed” block if at least 50 percent of the pixels in the block exceed the difference threshold, T_{occ}.

In an exemplary embodiment of the present invention, an occlusion event may be triggered if an occluding object consists of at least 30 blocks.

An occlusion event may be marked and maintained as long as subsequent frames contain an occluding object of sufficient size, located abutting a frame boundary. These subsequent frames may not be stored or analyzed for content change. Once a subsequent frame is received for which there is no occlusion event detected, the frame may be analyzed to detect new content.

In some embodiments of the present invention, dis-occlusion detection may comprise the same process as occlusion detection, with a dis-occlusion event triggered when there are no occluding objects detected or when there are no occluding objects of sufficient size to trigger an occlusion event.

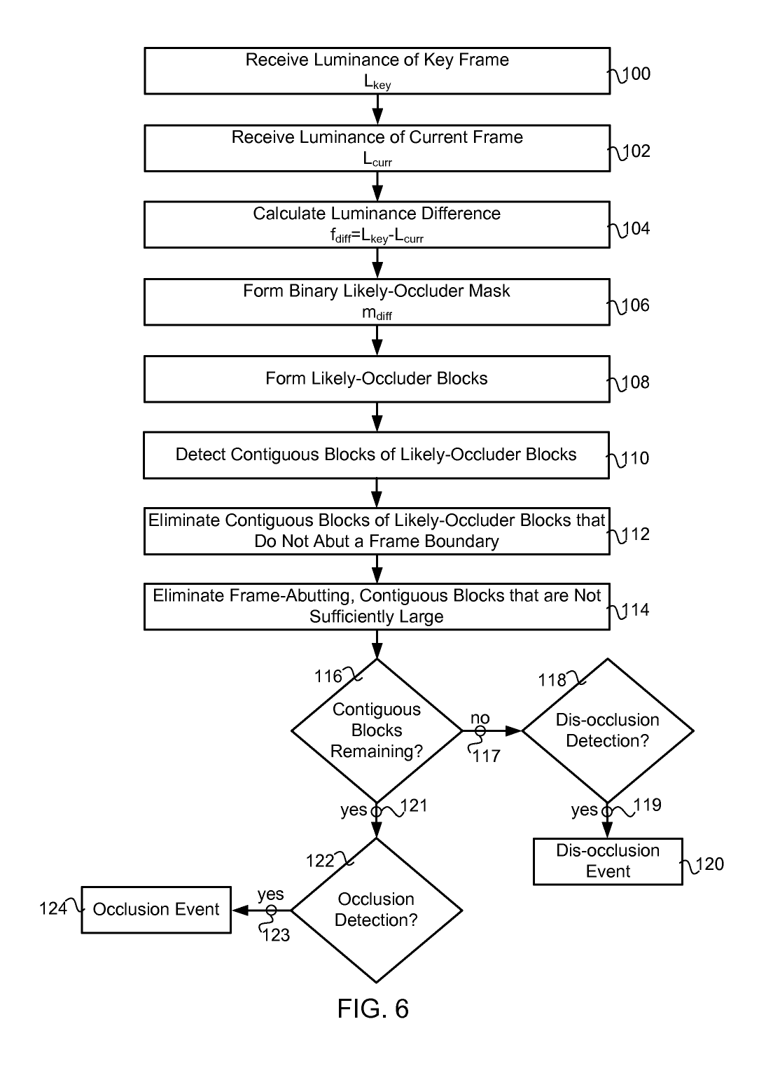

An exemplary embodiment of occlusion detection and dis-occlusion detection according to embodiments of the present invention may be understood in relation to FIG. 6. In these exemplary embodiments, a luminance image, L_{key}, associated with a key frame may be received 100. A luminance image, L_{curr}, associated with a current frame may be received 102. A luminance difference image, f_{diff}, may be calculated 104 according to:

f_{diff}=L_{key}−L_{curr}.

A binary likely-occluder mask, m_{diff}, may be formed 106 according to:

$${m}_{diff} ( i , j ) = \{ \begin{matrix}1 , & {f}_{diff} ( i , j ) > {T}_{occ} \\ 0 , & otherwise ,\end{matrix}$$

and likely-occluder blocks, also referred to as changed blocks, may be formed 108 from the binary likely-occluder mask.

The likely-occluder blocks may be formed 108 by dividing the binary likely-occluder mask, m_{diff}, into non-overlapping blocks, and the number of pixels in each block that exceed a difference threshold, T_{occ}, may be counted. If the count for a block exceeds a block-density threshold, which may be denoted T_{bden}, then the block maybe marked as a “changed” block, also referred to as a likely-occluder block. Contiguous “changed” blocks may be detected 110. Contiguous “changed” blocks that do not abut a frame boundary may be eliminated 112 as likely-occluder blocks. The size of remaining contiguous “changed” blocks may be used to eliminate 114 frame-abutting, contiguous blocks that are not sufficiently large enough to be associated with an occluding object.

If there are no contiguous “changed” blocks remaining 117 after elimination based on location 112 and size 114, then if dis-occlusion detection is being performed 119, a dis-occlusion event may be declared 120. If there are contiguous “changed” blocks remaining 121 after elimination based on location 112 and size 114, then if occlusion detection is being performed 123, an occlusion event may be declared 124. Otherwise, the current dis-occlusion/occlusion state may be maintained.

In some embodiments of the present invention, edge information in the current image frame and the reference image frame may be computed to determine changes, also considered updates, to the collaborative writing surface. The gradient of the current image may be calculated, and the current gradient image may be divided into non-overlapping blocks. For each block, the number of edge pixels for which the gradient magnitude exceeds a threshold, which may be denoted T_{g}, may be calculated. An edge count associated with a block in the current gradient image may be compared to the edge count associated with the corresponding block in a reference gradient image that represents the state of the collaborative writing surface prior to the occlusion event. If the number of edge pixels in one or more blocks has sufficiently changed, it may be concluded that the current frame includes significant content changes, and the current frame may be stored as part of the collaboration session. In some embodiments, to determine if a sufficient number of edge pixels in a block has changed, the ratio of the number edge pixels changed in the block of the current gradient image relative to the corresponding block in the reference gradient image may be compared to a threshold, which may be denoted T_{b}. The block may contain significant content change if the ratio meets a first criterion, for example, is greater than or is greater than or equal to, in relation to the threshold value. The reference block edge information may be updated using the current block edge information.

The values of the gradient threshold, T_{g}, and the block edge change detection threshold, T_{b}, may be selected in various ways. In one embodiment of the invention, T_{g} and T_{b} may be set empirically to 800 and 0.25, respectively.

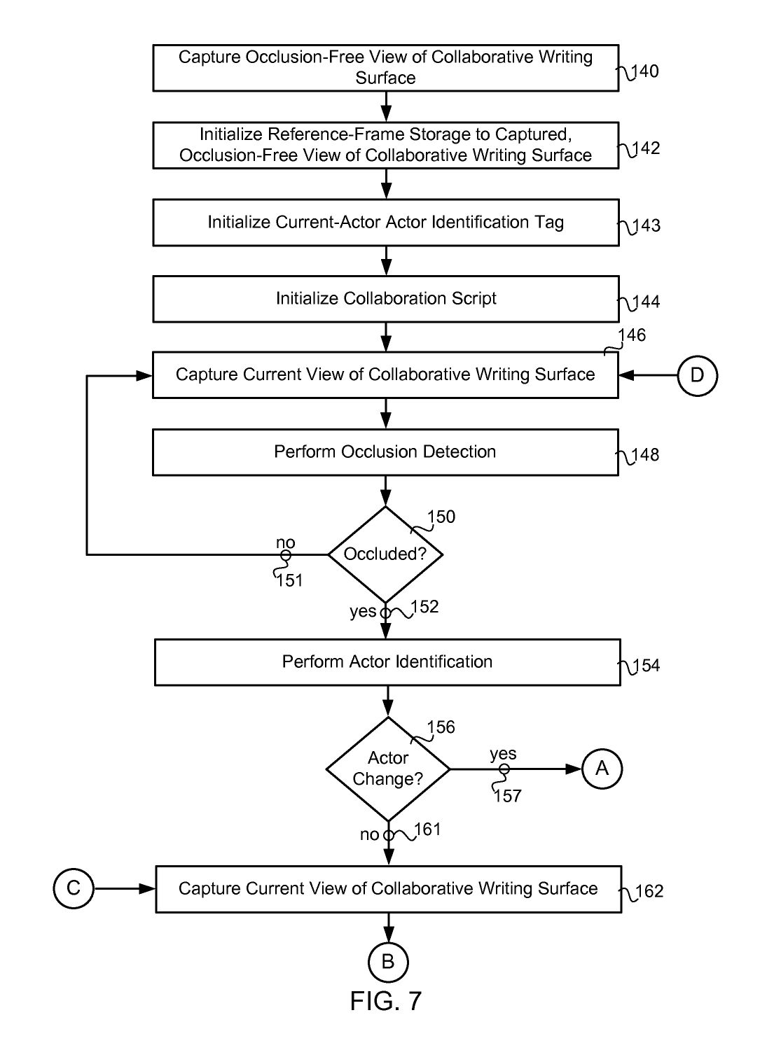

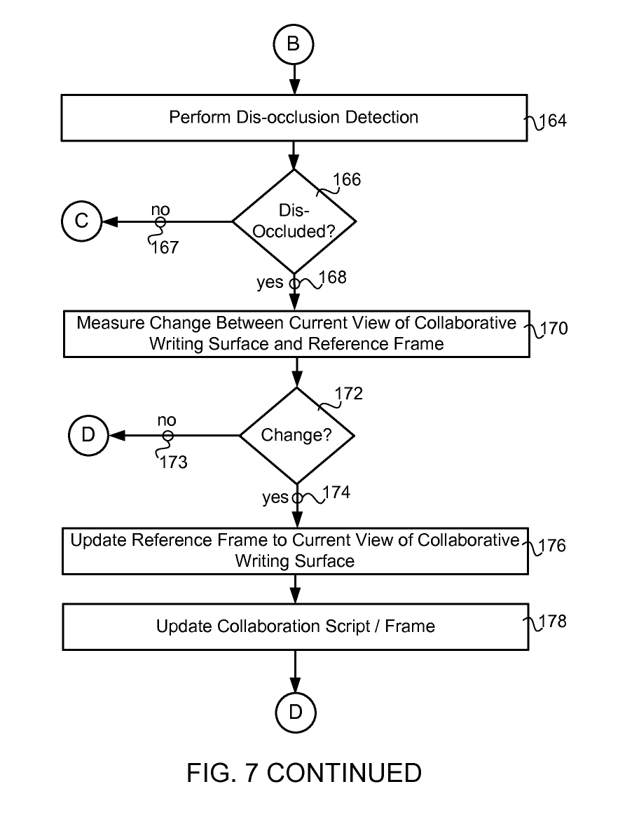

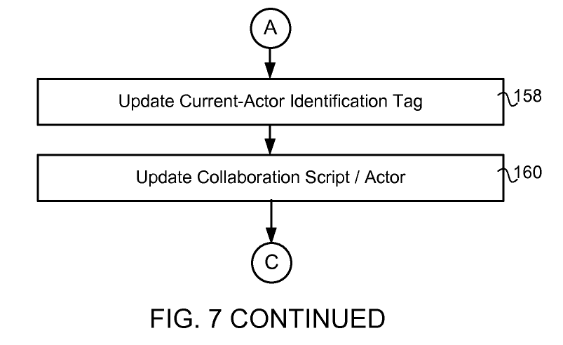

In some embodiments of the present invention described in relation to FIG. 7, an actor may be associated with each occlusion/dis-occlusion event. The actor associated with the occlusion/dis-occlusion event may be identified by an actor identification tag. In some embodiments of the present invention, the actor identification tag may be the person's name or other unique alphanumeric identifier associated with the person. In alternative embodiments, the actor identification tag associated with a person may be a picture, or image, of the person. In some of these embodiments, the picture may be a real-time-captured picture captured during the collaborative session. In alternative embodiments, the picture may be a previously captured picture stored in a database, or other memory, associated with the collaboration system.

In these actor-identified embodiments, an occlusion-free view of a collaborative writing surface may be captured 140. A memory, buffer or other storage associated with a reference frame, also considered a reference image, may be initialized 142 to the captured, occlusion-free view of the collaborative writing surface, and a current-actor actor identification tag may be initialized 143 to an initial tag value. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session. A collaboration script associated with the collaboration session may be initialized 144. In some embodiments of the present invention, the collaboration script may initially comprise the occlusion-free view of the collaborative writing surface and the initial current-actor actor identification tag. In alternative embodiments of the present invention, the collaboration script may be initialized to a “null” indicator.

A current view of the collaborative writing surface may be captured 146, and occlusion detection may be performed 148. The captured current view of the collaborative writing surface may be referred to as the current frame, or current image. If no occluding event is detected 151, then the current-view capture 146 and occlusion detection 148 may continue. If an occluding event is detected 152, actor identification may be performed 154. In some embodiments of the present invention, actor identification 154 may comprise facial recognition. In alternative embodiments of the present invention, actor identification 154 may comprise voice recognition. In still alternative embodiments of the present invention, actor identification 154 may comprise querying collaboration participants for the actor identification tag.

If an actor change is detected 157 relative to the current-actor actor identification tag, then the current-actor actor identification tag may be updated 158 and a collaboration script associated with the current collaboration session may be updated 160 to reflect the change in actor. The current view of the collaborative writing surface may then be captured 162, as it would be if no change in actor is detected 161.

After the current view of the collaborative writing surface is captured 162, dis-occlusion detection 164 may be performed. While the current view remains occluded 167, the current-view capture 162 and dis-occlusion detection 164 may continue. When the current view is determined 166 to be dis-occluded 168, then the change between the current frame and the reference frame may be measured 170. If there is no measured change 173, then the current-view capture 146 and occlusion detection 148 continue. If there is a measured change 174, then the reference frame may be updated 176 to the current frame by writing the current frame data to the memory, buffer or other storage associated with the reference frame, and the collaboration script may be updated 178 to reflect the new view of the collaborative writing surface. The current-view capture 146 and occlusion detection 148 may then continue.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

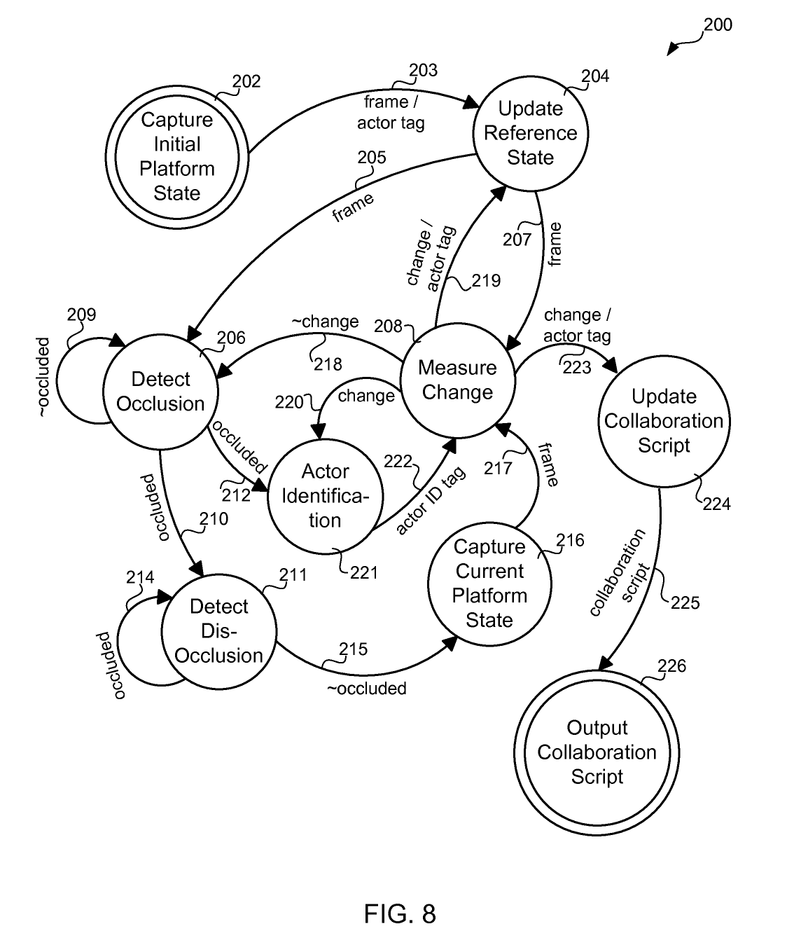

Some embodiments of the present invention may be understood in relation to a finite state machine (FSM) diagram 200 shown in FIG. 8. Some embodiments of the present invention may comprise the finite state machine 200 embodied in hardware. Alternative embodiments of the present invention may comprise the finite state machine 200 embodied in a computer-program product that is a computer-readable storage medium, and/or media, having instructions stored thereon, and/or therein, that may be used to program a computer to perform the features of the finite state machine 200. Still alternative embodiments may comprise the finite state machine 200 embodied in a combination of hardware and a computer-program product that is a computer-readable storage medium, and/or media, having instructions stored thereon, and/or therein, that may be used to program a computer to perform the features of the finite state machine 200.

An initial platform state may be captured 202, and the capture may trigger a transition 203 to an “update-reference-state” state 204 in which the image frame associated with the initial capture may be used to initialize a reference frame, also referred to as a reference image, associated with the collaboration system and an initial actor identification tag may be used to initialize a current-actor identification tag. In some embodiments of the present invention, the initial platform state may be associated with an unobstructed view of the collaborative writing surface. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session.

The updating of the reference image may trigger a state transition 205 to a “detect-occlusion” state 206, in which it may be determined whether or not the view of the collaborative writing surface is obstructed, and a state transition 207 to a “measure-change” state 208, in which the change between an image associated with the current platform state and the reference image may be measured and in which the change between a currently identified actor and a reference actor may be measured. From the “detect-occlusion” state 206, if there is no occlusion detected, the system may remain 209 in the “detect-occlusion” state 206. If there is occlusion detected, the system may transition 210 to a “detect-dis-occlusion” state 211, in which it may be determined whether or not the view of the collaborative writing surface is unobstructed. From the “detect-dis-occlusion” state 211, if there is no dis-occlusion detected, the system may remain 214 in the “detect-dis-occlusion” state 211. If there is dis-occlusion detected, the system may transition 215 to a “capture-current-platform” state 216, in which the current state of the platform may be captured. The capture of the dis-occluded frame may trigger a transition 217 to the “measure-change” state 208. If there is no measured change between the current frame and the reference frame, the system may transition 218 to the “detect-occlusion” state 206. If there is measurable change, then the system may transition 219 to the “update-reference-frame” state 204. Measureable change may also cause a transition 220 from the “measure-change” state 208 to an “actor-identification” state 221, in which the actor currently in view may be identified. Additionally, a detection of occlusion in the “detect-occlusion” state 206 may cause a transition 212 from the “detect-occlusion” state 206 to the “actor-identification” state 221. Determination of an actor ID tag may cause a transition 22 to the “measure-change” state 208. Detection of change in the un-occluded image or the actor identification tag may trigger a transition 223 to an “update-collaboration-script” state 224, in which a collaboration script associated with the collaboration session may be updated. Updating the collaboration script may trigger a state transition 225 to an “output-collaboration-script” state 226, in which the updated collaboration script may be made available to collaboration partners, a collaboration archive, a collaboration journal or other collaboration repository.

In some embodiments of the present invention, a reference frame may be shared, at each update, for viewing, archiving, journaling or other collaborative tasks. In some exemplary embodiments of the present invention, an updated reference frame may be sent from the host computing system to any device authenticated to participate in the collaboration session. In alternative exemplary embodiments of the present invention, an updated reference frame may be sent from the host computing system to a memory location for archival or journaling purposes. In some of these embodiments, the memory location may be accessed by session participants to download a portion of the collaboration record.

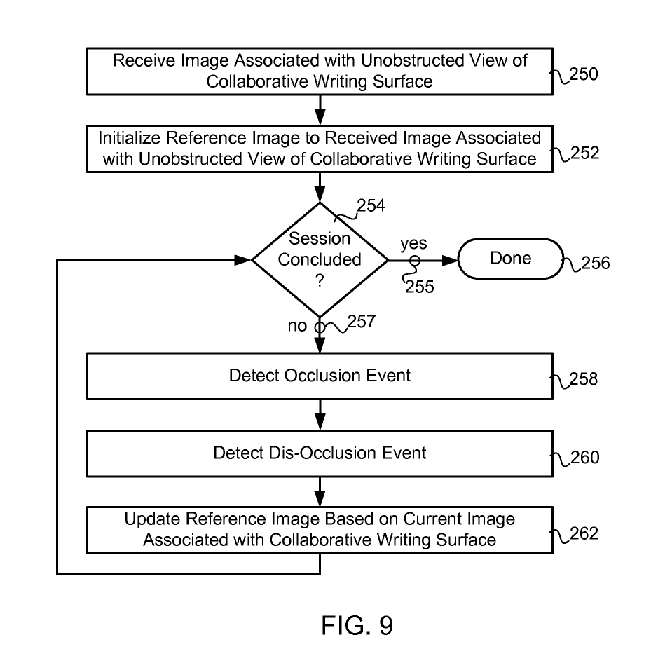

Some embodiments of the present invention described in relation to FIG. 9 may relate to capturing and sharing information from a collaborative writing surface during a collaboration session and may comprise receiving 250 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 252 to the received image associated with the unobstructed view of the collaborative writing surface. If the collaboration session has concluded 255, then the capturing and sharing of the information from the collaborative writing surface may be terminated 256. If the collaboration session has not concluded 257, then occlusion detection may be performed until an occlusion event is detected 258. In some embodiments of the present invention, occlusion detection may be performed according to any of the above-described methods and systems of the present invention. After an occlusion event is detected, dis-occlusion detection may be performed until a dis-occlusion event is detected 260, and the reference image may be updated 262 based on a currently captured image of the collaborative writing surface. In some embodiments of the present invention, dis-occlusion detection may be performed according to any of the above-described methods and systems of the present invention. In some embodiments of the present invention, the reference image may be updated 262 to the current image associated with the collaborative writing surface. In alternative embodiments of the present invention, the reference image may be updated 262 based on changes between the current image associated with the collaborative writing surface and reference image. After the reference image has been updated 262, then the session-concluded determination 254 may be made.

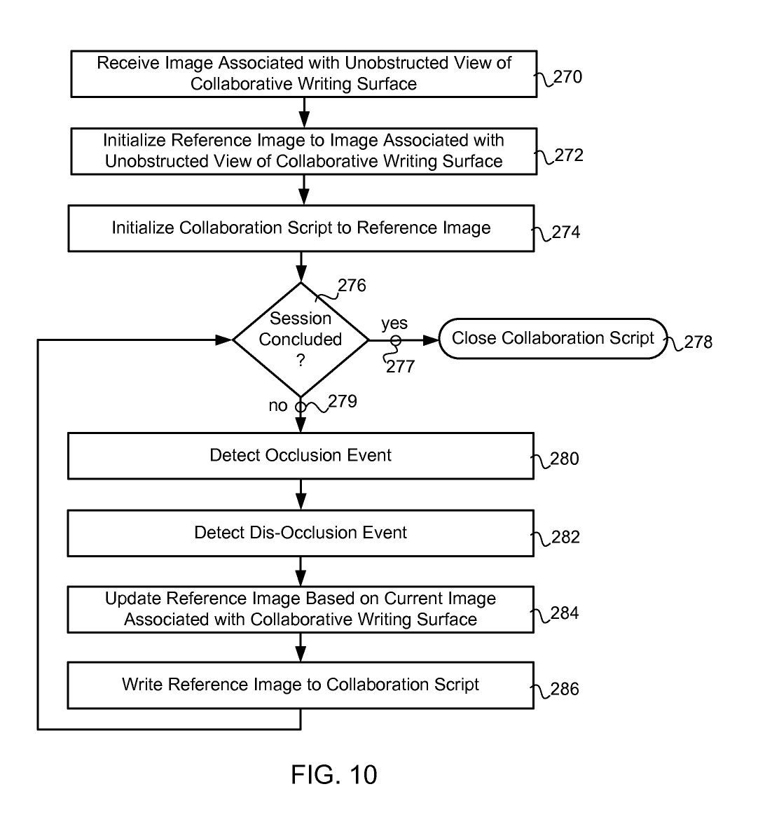

Some embodiments of the present invention described in relation to FIG. 10 may relate to capturing and sharing information from a collaborative writing surface during a collaboration session and may comprise receiving 270 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 272 to the received image associated with the unobstructed view of the collaborative writing surface, and a collaboration script may be initialized 274 to comprise the reference image. If the collaboration session has concluded 277, then the capturing and sharing of the information from the collaborative writing surface may be terminated by closing the collaboration script 278. If the collaboration session has not concluded 279, then occlusion detection may be performed until an occlusion event is detected 280. In some embodiments of the present invention, detection of an occlusion event may be performed according to any of the above-described methods and systems of the present invention. After an occlusion event is detected, dis-occlusion detection may be performed until a dis-occlusion event is detected 282, and the reference image may be updated 284 based on a currently captured image of the collaborative writing surface. In some embodiments of the present invention, dis-occlusion detection may be performed according to any of the above-described methods and systems of the present invention. In some embodiments of the present invention, the reference image may be updated 284 to the current image associated with the collaborative writing surface. In alternative embodiments of the present invention, the reference image may be updated 284 based on changes between the current image associated with the collaborative writing surface and reference image. The updated reference image may be written to the collaboration script 286, and the check may be made 276 to determine if the collaboration session has concluded.

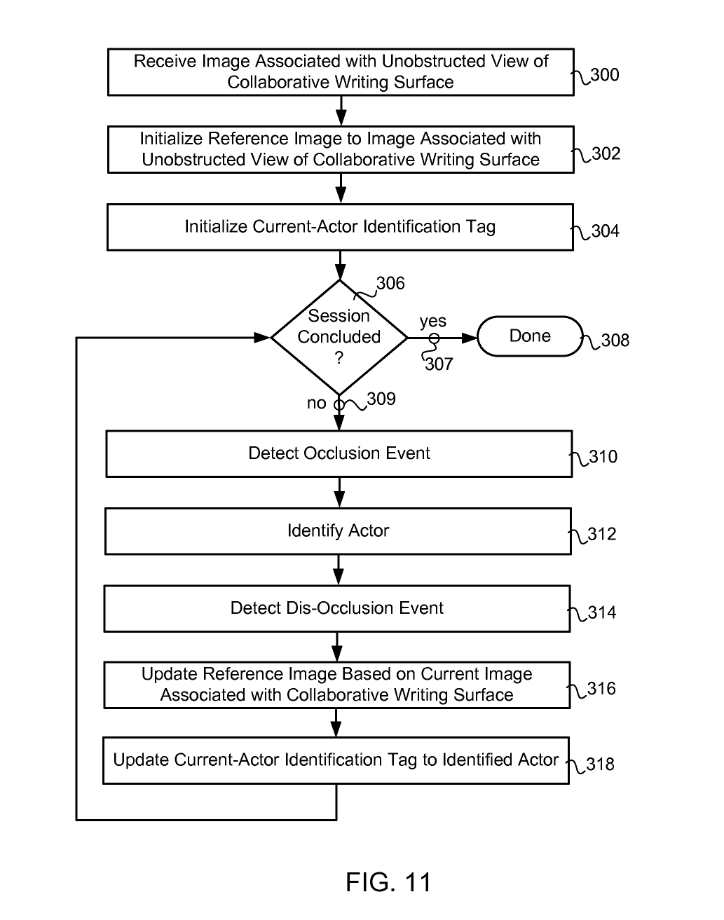

Some embodiments of the present invention described in relation to FIG. 11 may relate to capturing and sharing information from a collaborative writing surface during a collaboration session and may comprise receiving 300 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 302 to the received image associated with the unobstructed view of the collaborative writing surface, and a current-actor identification tag may be initialized 304. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session.

If the collaboration session has concluded 307, then the capturing and sharing of the information from the collaborative writing surface may be terminated 308. If the collaboration session has not concluded 309, then occlusion detection may be performed until an occlusion event may be detected 310. In some embodiments of the present invention, detection of an occlusion event may be performed according to any of the above-described methods and systems of the present invention. An actor associated with the occlusion event may be identified 312, and dis-occlusion detection may be performed until a dis-occlusion event may be detected 314. The reference image may be updated 316 based on a currently captured image of the collaborative writing surface. In some embodiments of the present invention, dis-occlusion detection may be performed according to any of the above-described methods and systems of the present invention. In some embodiments of the present invention, the reference image may be updated 316 to the current image associated with the collaborative writing surface. In alternative embodiments of the present invention, the reference image may be updated 316 based on changes between the current image associated with the collaborative writing surface and reference image. The current-actor identification tag may be updated 318 to the identified actor. After the reference image and the current-actor identification tag have been updated 316, 318, then the session-concluded determination 306 may be made.

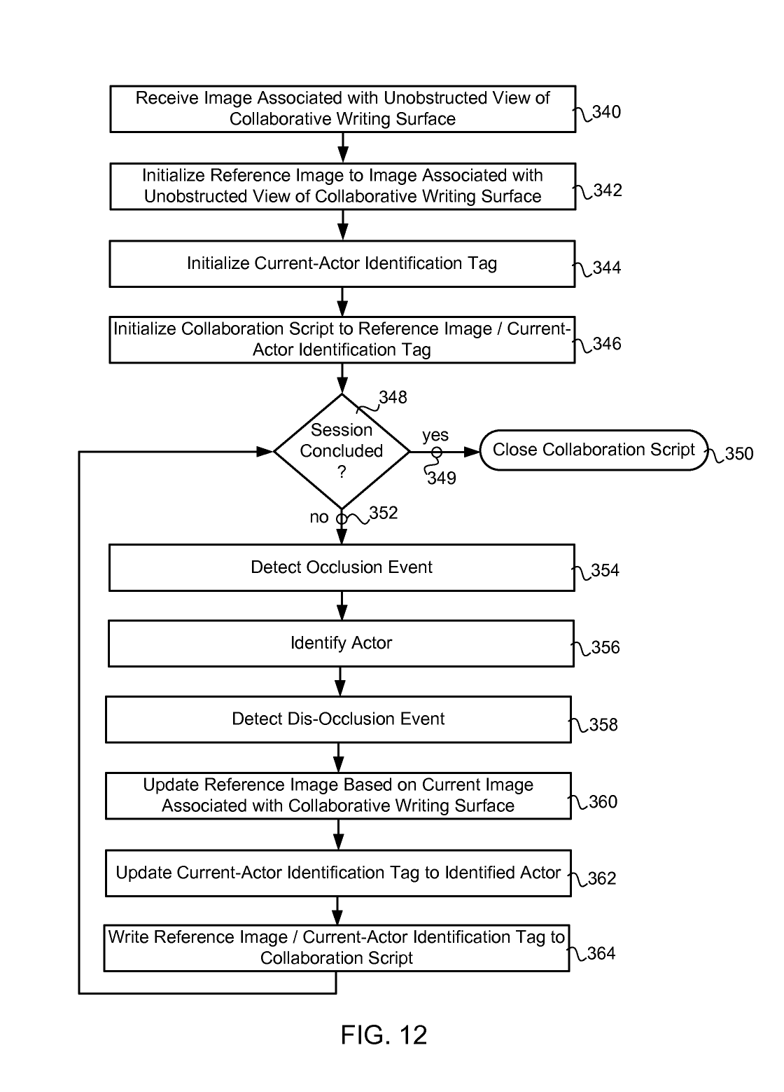

Some embodiments of the present invention described in relation to FIG. 12 may relate to capturing and sharing information from a collaborative writing surface during a collaboration session and may comprise receiving 340 an image associated with an unobstructed view of a collaborative writing surface. In some embodiments of the present invention, the received image may comprise an image that may have been demosaiced to reconstruct coincident three-color output data from non-coincident samples obtained by a camera filter array associated with an image-acquisition system, for example, a video camera. In some embodiments of the present invention, the received image may comprise an image that may have been corrected for perspective distortion introduced by the relative position of image-acquisition system and the collaborative writing surface.

A reference image may be initialized 342 to the received image associated with the unobstructed view of the collaborative writing surface, and a current-actor identification tag may be initialized 344. In some embodiments of the present invention, the initial current-actor actor identification tag may be a “null” indicator indicating that there is no actor currently associated with the collaborative session. In alternative embodiments, the initial current-actor actor identification tag may be a default value, for example, the identification tag may be associated with the person who organized the collaborative session. In yet alternative embodiments, the initial current-actor actor identification tag may be set by prompting for user input at the initialization of the collaborative session. A collaboration script may be initialized 346 to comprise the reference image and current-actor identification tag.

If the collaboration session has concluded 349, then the capturing and sharing of the information from the collaborative writing surface may be terminated 350 by closing the collaboration script. If the collaboration session has not concluded 352, then occlusion detection may be performed until an occlusion event may be detected 354. In some embodiments of the present invention, detection of an occlusion event may be performed according to any of the above-described methods and systems of the present invention. An actor associated with the occlusion event may be identified 356, and dis-occlusion detection may be performed until a dis-occlusion event may be detected 358. The reference image may be updated 360 based on a currently captured image of the collaborative writing surface. In some embodiments of the present invention, dis-occlusion detection may be performed according to any of the above-described methods and systems of the present invention. In some embodiments of the present invention, the reference image may be updated 360 to the current image associated with the collaborative writing surface. In alternative embodiments of the present invention, the reference image may be updated 360 based on changes between the current image associated with the collaborative writing surface and reference image. The current-actor identification tag may be updated 362 to the identified actor. After the reference image and the current-actor identification tag have been updated 360, 362, then the updated reference image and current-actor identification tag may be written to the collaboration script. The session-concluded determination 348 may be made.

Semantic Attachment

In some embodiments of the present invention, semantic meaning may be attached to a detected marking, referred to as a semantic marking, on a collaborative writing surface. In some embodiments, the semantics associated with the semantic marking may influence how a writing-surface record, also referred to as a collaboration script, associated with the collaborative writing surface may be updated. In alternative embodiments, the semantics associated with the semantic marking may relate to a process that may be initiated when the semantic marking is detected. Exemplary processes may include tagging, summarization, routing, optical character recognition and other processes associated with the writing-surface record.

In some embodiments, by making a semantic marking on a collaborative writing surface, a collaboration participant may influence the physical appearance of a portion of the content of a writing-surface record associated with the collaborative writing surface. For example, a semantic marking may be associated with a text color, a non-color text attribute (such as, bold, underlined and other non-color text attributes), a highlight color and other physical-appearance attributes.

In some embodiments, an action may be associated with a semantic marking. Exemplary actions may include the tagging, in the writing-surface record, of a region of the collaborative writing surface with a metadata tag, the attachment of a routing schedule to a region of the collaborative writing surface recorded in the writing-surface record, the initiation of a post-processing process on the writing-surface record, for example, optical character recognition or content summarization, in conjunction with a region of the collaborative writing surface and other actions.

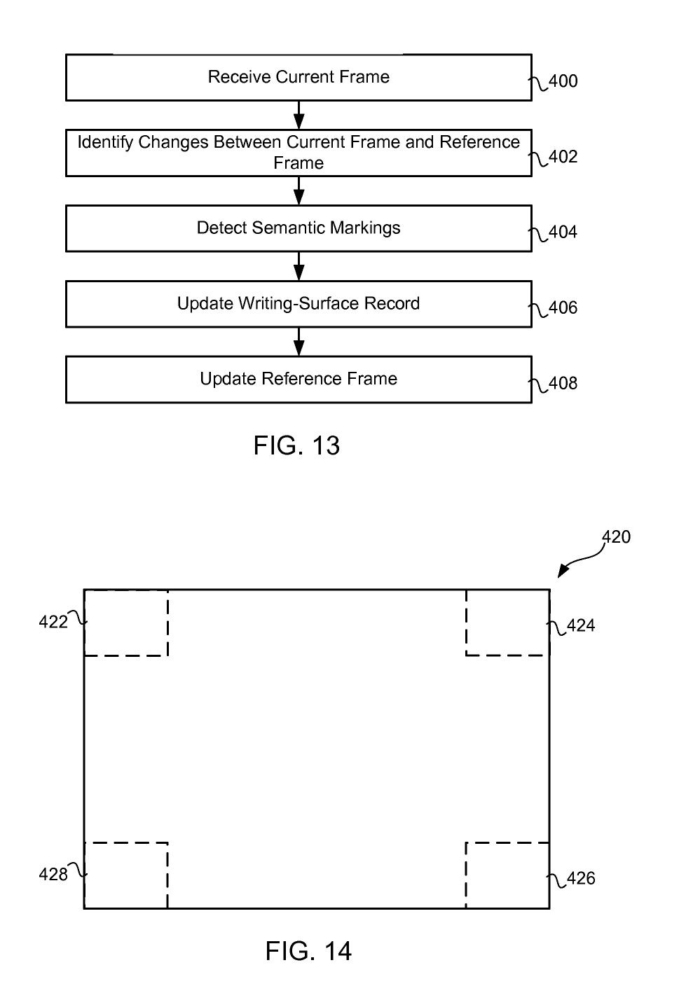

Some embodiments of the present invention described in relation to FIG. 13 may comprise receiving 400 a current frame, also referred to as a new frame. In some of these embodiments, the current frame may be a frame captured in response to the detection of an occlusion/dis-occlusion event pair according to the above-described embodiments of the present invention. In alternative embodiments, the current frame may be a frame captured in response to a capture request associated with the collaborative writing surface, for example, a participant-initiated capture request or other capture request. Changes between the current frame and a reference frame stored in association with the collaboration session may be identified 402, and semantic markings may be detected 404 in the changes between the current frame and the reference frame. A writing-surface record may be updated 406 in accordance with the detected semantic markings, and the reference frame may be updated 408 based on the changes detected between the current frame and the reference frame.

In some embodiments of the present invention, the writing-surface record may be initialized to the initial reference frame.

Exemplary embodiments of the present invention may be understood in relation to FIG. 14. FIG. 14 shows an exemplary collaborative writing surface 420. Each of the four corner regions 422, 424, 426, 428 of the collaborative writing surface may be reserved for semantic markings. These regions 422, 424, 426, 428 may be referred to as semantic-significant regions. For example, when a mark is made in the upper-left semantic-significant region 422, this semantic marking may be associated with a red-colored pen, and some updates to the writing-surface record associated with the collaborative writing surface 420 may be reflect this semantic attachment. Similarly, a semantic marking in the upper-right semantic-significant region 424 may be associated with a blue-colored pen, a semantic marking in the lower-right semantic-significant region 426 may be associated with a yellow highlighter, and a semantic marking in the lower-left semantic-significant region 428 may be associated with a green-colored pen. In some of these embodiments, the shape, size and other physical attributes of the semantic marking may be unimportant as long as the semantic marking is within a reserved semantic-significant region. In alternative embodiments, a semantic marking may be required to be larger than a minimum size to be considered relevant. In some embodiments, the size of a semantic marking may be measured by determining the area of the minimum bounding box of the semantic marking. In alternative embodiments, the size of a semantic marking may be measured by determining the extent of the semantic marking in a first image direction (for example, one of the horizontal image direction and the vertical image direction) and the extent of the semantic marking in a second direction (for example, the other of the horizontal image direction and the vertical image direction).

Alternative configurations of semantic-significant regions may be envisioned. For example, the semantic-significant regions may be configured in a toolbar configuration or other arrangement.

When a marking in a semantic-significant region is detected, the writing-surface record may be updated in accordance with the detected semantic marking. In some embodiments of the present invention, content added to the collaborative writing surface may be added to the writing-surface record with a property defined by the detected semantic marking. As an example, if a blue-colored-pen semantic marking is detected in relation to an occlusion/dis-occlusion event pair, then the new text content added to the writing-surface record will be colored blue. As another example, if a yellow-highlight-color semantic marking is detected in relation to an occlusion/dis-occlusion event pair, then the next text content added to the writing-surface record may be highlighted in yellow. In some embodiments of the present invention, a minimum bounding box of the new text content may be identified, and the pixels in the minimum bounding box may be set to the highlight color without overwriting any existing marks and the new text content.

In some embodiments of the present invention, the attribute associated with a detected semantic marking may remain in effect until a new semantic marking associated with an attribute that is inconsistent with the current attribute is detected. In alternative embodiments, the attributed associated with a detected semantic marking may remain in effect until the removal of the semantic marking from the collaborative writing surface is detected. In some of these embodiments, a default attribute may be associated with newly added content. For example, upon the removal of a semantic marking associated with a blue-colored pen, the text color may revert to a default text color, for example, black.

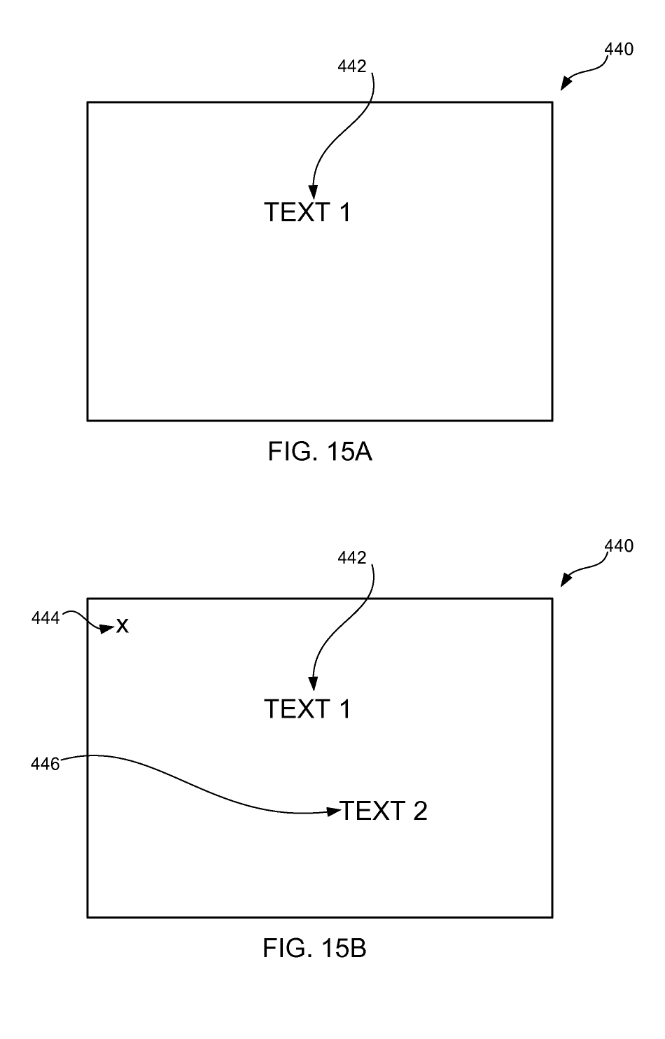

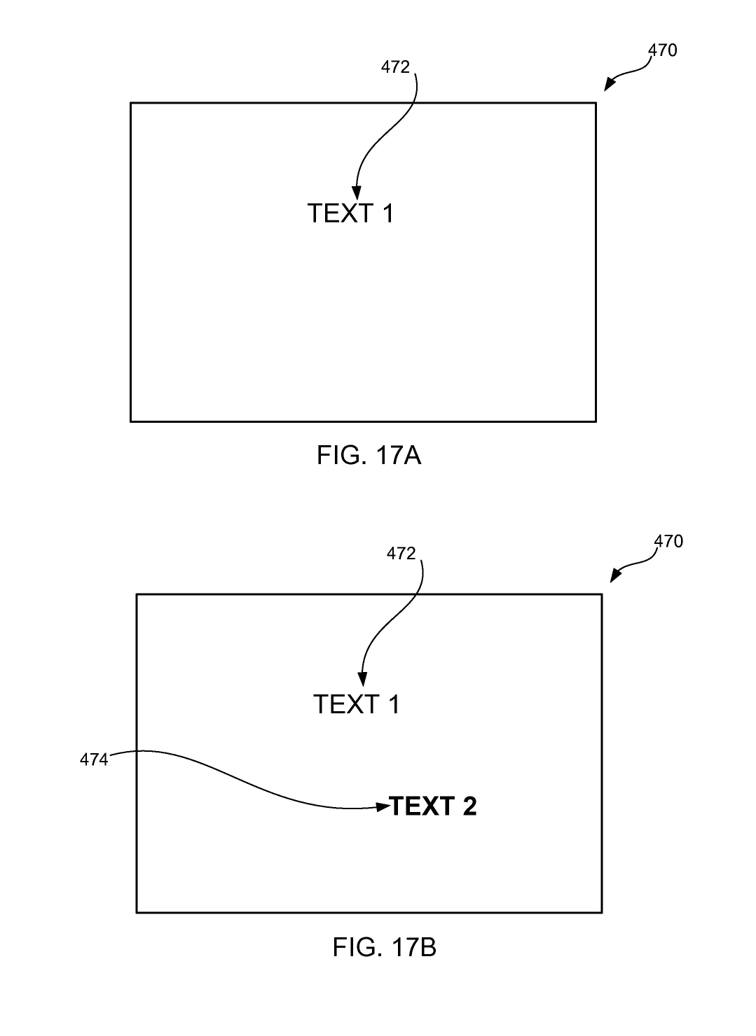

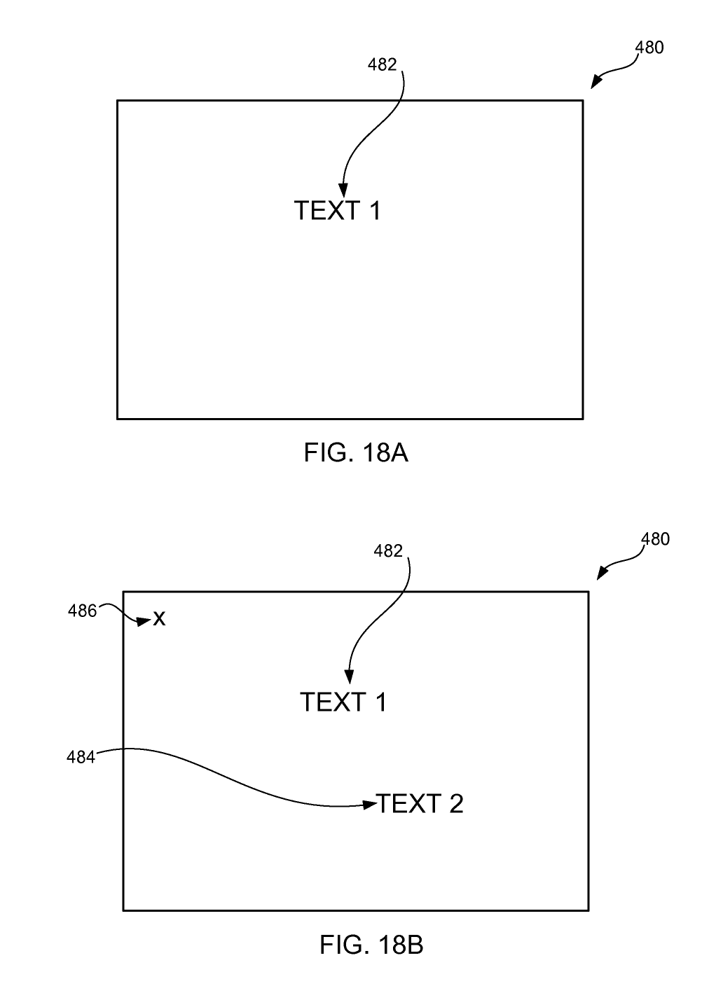

Some embodiments of the present invention may be further understood in relation to an example described in relation to FIGS. 15-18. FIG. 15A depicts an exemplary collaborative writing surface 440, at a first time, on which there is a first line of text 442 written. FIG. 17A depicts the corresponding writing-surface record 470 containing the first line of text 472, and FIG. 18A depicts the corresponding reference frame 480 containing the first line of text 482.

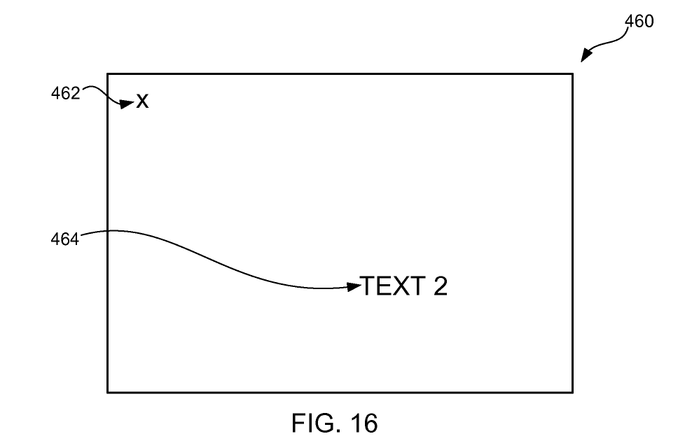

FIG. 15B depicts the collaborative writing surface 440 after the detection of an immediately subsequent capture event. The first line of text 442 remains on the collaborative writing surface 440, and a semantic marking 444 has been added to the collaborative writing surface 440, in addition to a second line of text 446. FIG. 16 shows an image 460 associated with the changes to the collaborative writing surface 440 shown in FIGS. 15A and 15B. The change image 460 comprises the semantic marking 462 and the newly added, second line of text 464. FIG. 17B depicts the writing-surface record 470 after analysis of the change image 460 and update in which the newly added, second line of text has be written in accordance with the semantic meaning of the semantic marking. In this example, the semantic marking is associated with a “bold” text attribute. Thus, in the writing-surface record 470, the newly added, second line of text 474 is written in a bold font. The reference image 480 reflects the current collaborative writing surface containing the two text lines 482, 484 and the semantic marking 486.

In some embodiments of the present invention, a semantic marking may be interpreted in conjunction with an additional marking. For example, a semantic marking indicating a highlighting function may be interpreted in relation to an indicator marking that may indicate the portion of the writing-surface record to which the highlight function should be applied.

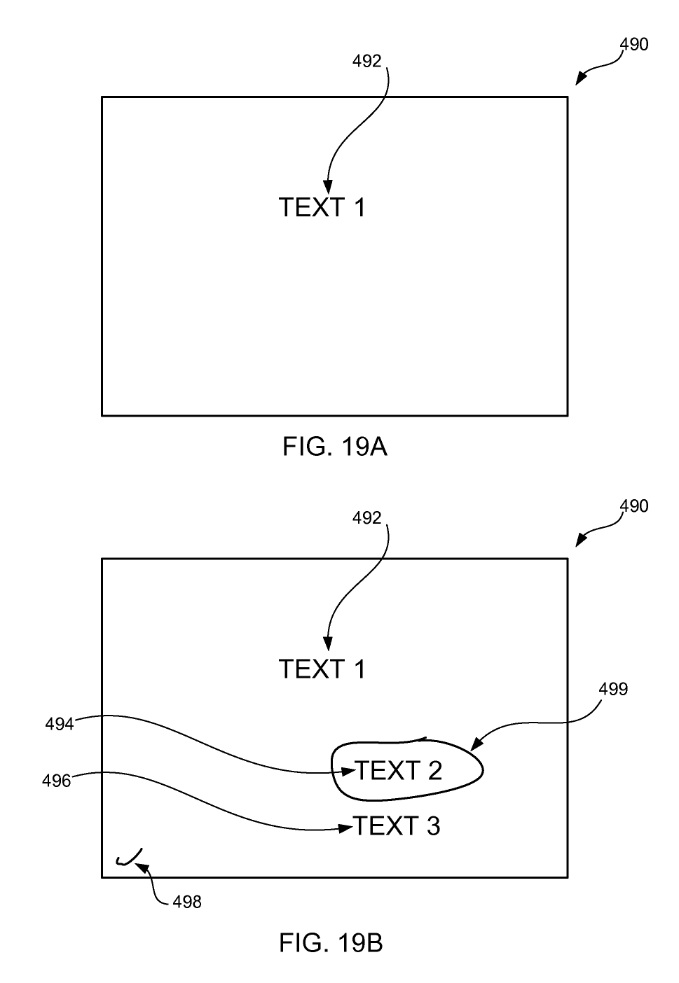

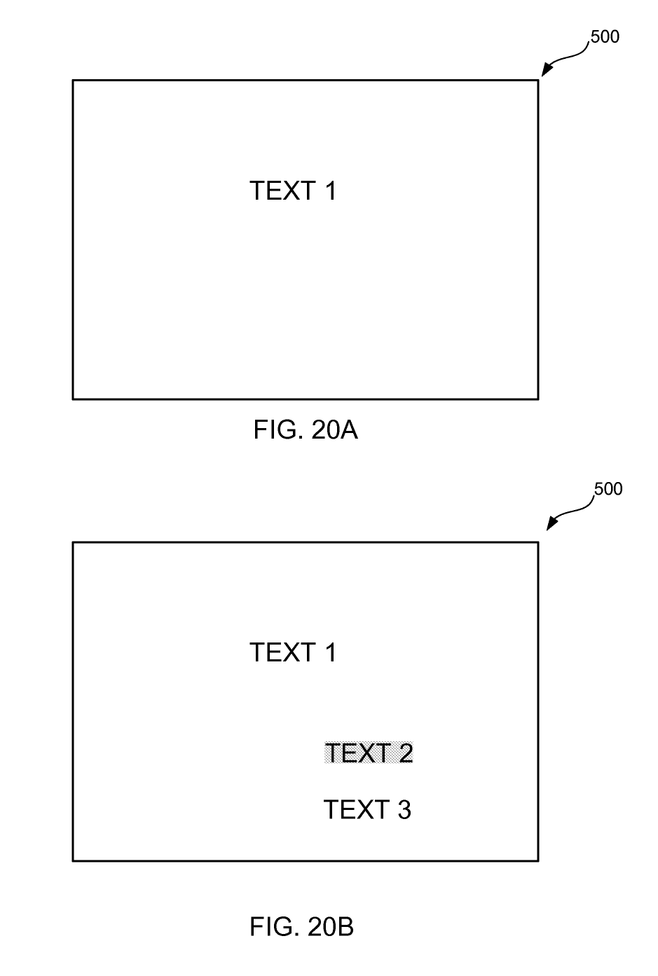

Exemplary embodiments may be understood in relation to FIG. 19 and FIG. 20. FIG. 19A depicts an exemplary collaborative writing surface 490, at a first time, on which one line of text 492 is written. FIG. 20A depicts the corresponding writing-surface record. FIG. 19B depicts the collaborative writing surface 490 after the detection of an immediately subsequent capture event. The first line of text 492 remains on the collaborative writing surface 490, and a second line of text 494, a third line of text 496, a semantic marking 498 and an indicator marking 499 have been newly added. The semantic marking 498 may be associated with a highlighting function, and the indicator marking 499 may indicate to which section of the collaborative writing surface the highlighting function should be applied. In some embodiments, a minimum bounding box associated with the content within the indicator marking 499 may be determined and the highlighting function may be applied within the minimum bounding box. FIG. 20B depicts the writing-surface record 500 corresponding to a highlighting function and a minimum bounding box. In alternative embodiments, the highlighting function may be applied to the entire region within the indicator marking 499.

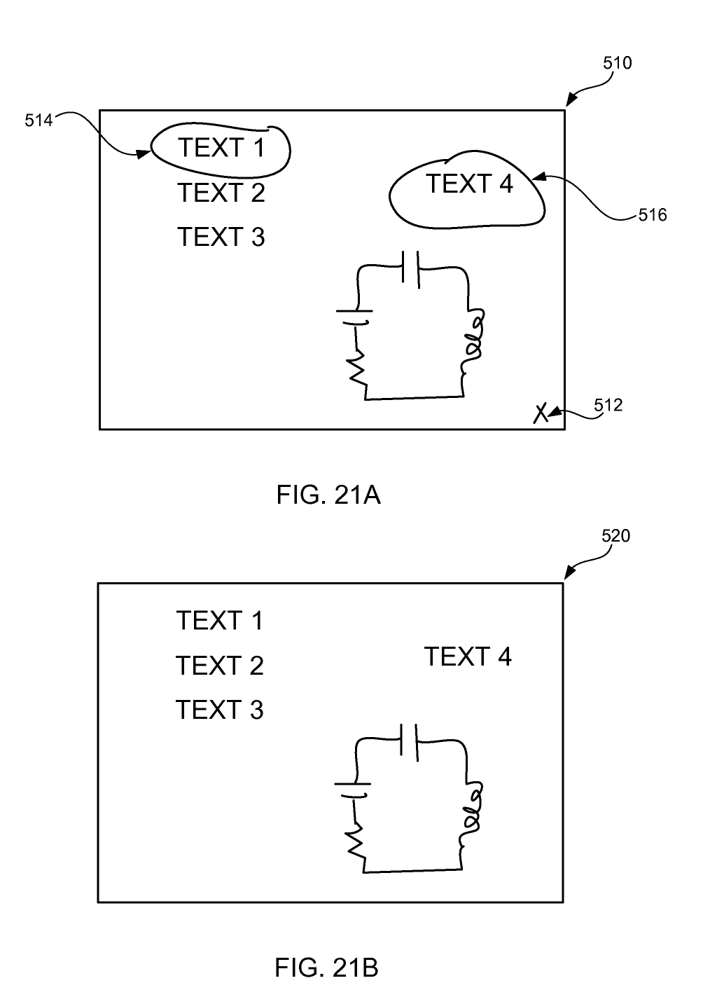

FIG. 21 illustrates other exemplary embodiments of the present invention in which detection of a semantic marking may initiate a process in relation to the content of a writing-surface record. An exemplary collaboration writing surface 510 is shown in FIG. 21A. The content of the exemplary collaboration writing surface may contain a newly added semantic marking 512 and two indicator markings 514, 516. Detection of the semantic marking 512 may initiate an optical character recognition program using the regions enclosed by the indicator markings 514, 516 as input. In some embodiments of the present invention, the results of the optical character recognition program may be associated with the writing-surface record as keywords related to the collaboration session to which the writing-surface record is associated. A search program may use the keywords in a search of a plurality of writing-surface records. The writing-surface record 520 may be shown in FIG. 21B.

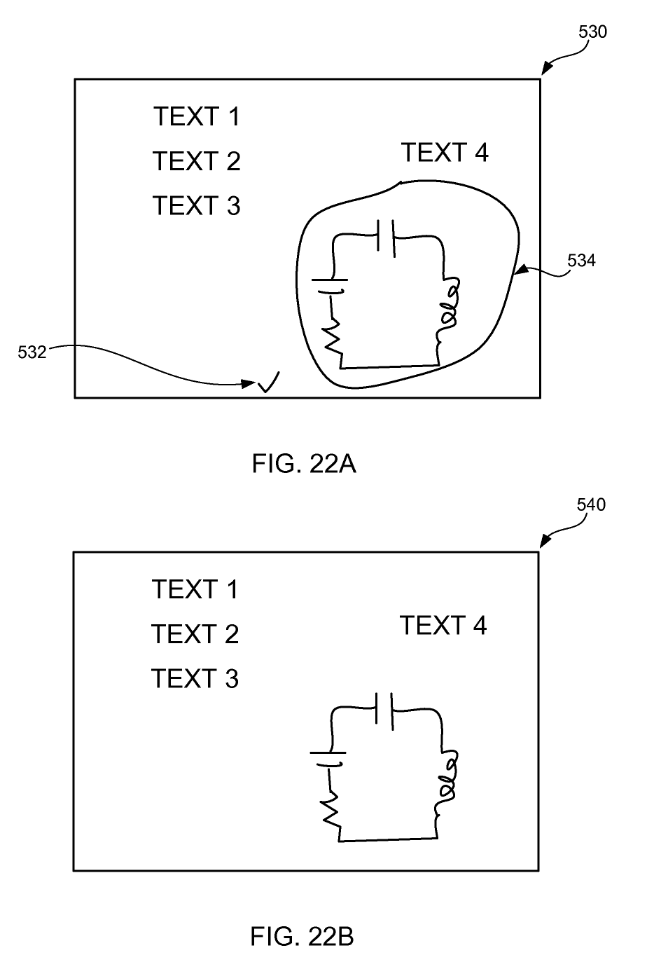

FIG. 22 illustrates yet other exemplary embodiments of the present invention in which detection of a semantic marking may initiate a process in relation to the content of a writing-surface record. An exemplary collaboration writing surface 530 is shown in FIG. 22A. The content of the exemplary collaboration writing surface may contain a newly added semantic marking 532 and an indicator marking 534. Detection of the semantic marking 532 may initiate routing of the content contained within the indicator marking 534 as input to a particular recipient or recipients. For example, the content may be routed to a draftsman for formal-drawing generation. In some embodiments of the present invention, the content may be sent as an attachment in an email to the recipient(s). In alternative embodiments, the content may be written as a file to a computer memory, and a notification may be sent to the recipient indicating the location of the file. In still alternative embodiments, the content may be written as a file to a predefined computer memory location, with or without implicit intended-recipient notification. The writing-surface record 540 may be shown in FIG. 22B.

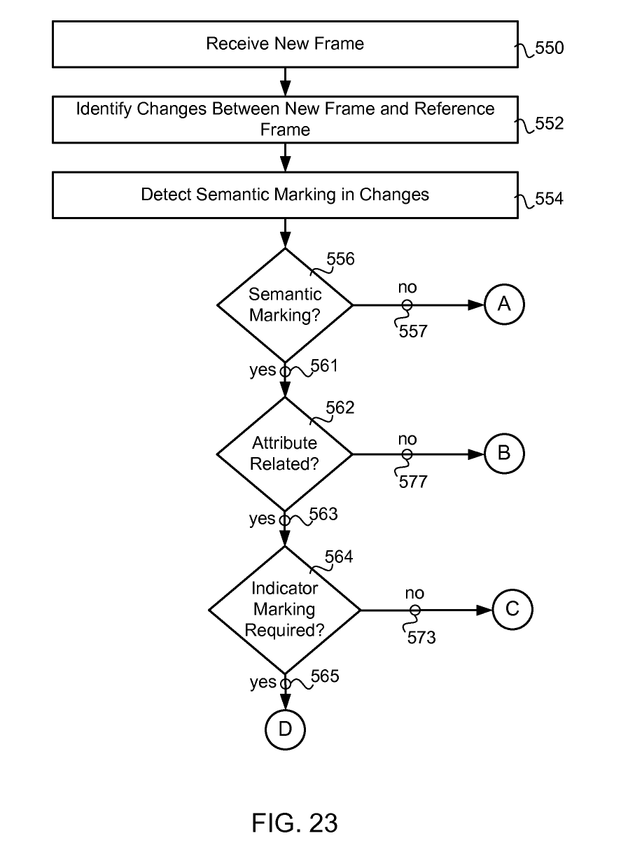

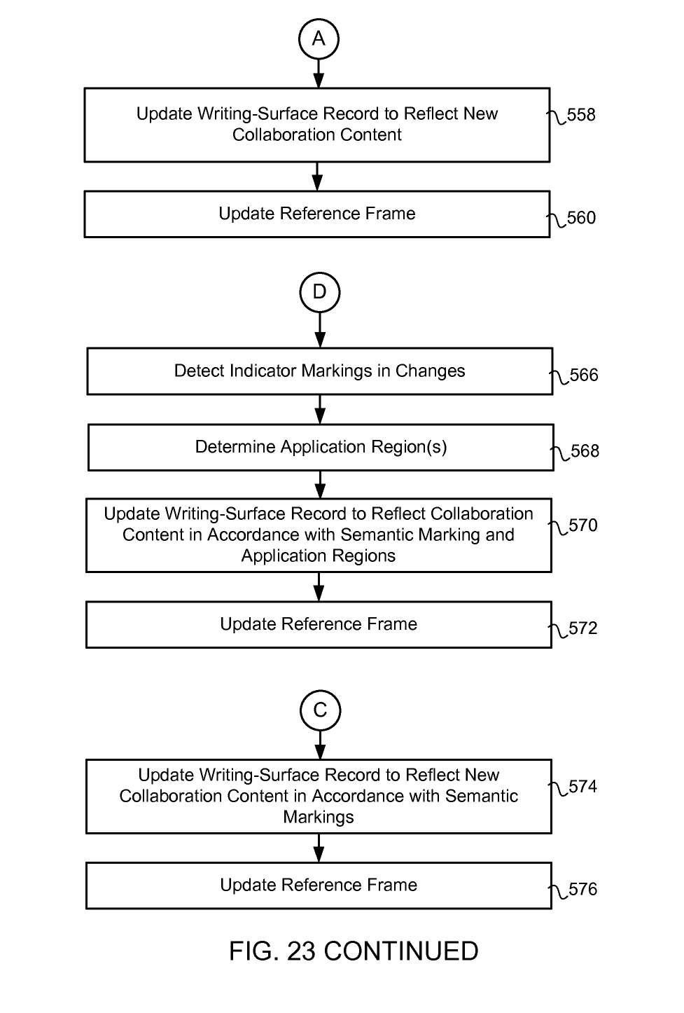

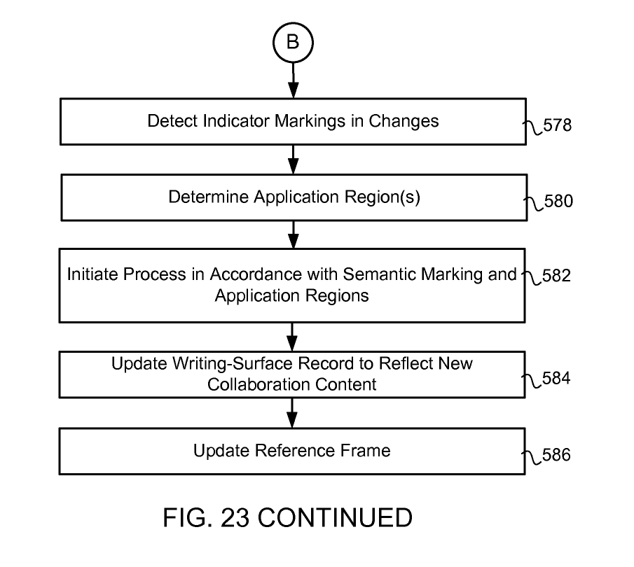

Some embodiments of the present invention may be described in relation to FIG. 23. In these embodiments, a new frame associated with a collaborative writing surface may be received 550 in response to a capture event. Changes may be identified 552 between the new frame and a reference frame. Semantic-marking detection 554 may be performed. In some embodiments of the present invention, semantic-marking detection 554 may comprise determining the number of changed pixels in each of the semantic-significant regions of the collaborative writing surface. If a semantic-significant region contains a sufficient number of changed pixels, then a semantic marking associated with that region may be detected. If there are no detected semantic markings 557, then the writing-surface record may be updated 558 to reflect the new collaboration content indicated by the changes. New collaboration content may refer to the changes that are not identified as semantic markings or indicator markings. The reference frame may be updated 560 to reflect the current collaboration writing surface content.

If a semantic marking is detected 561, then a determination 562 may be made as to whether or not the detected semantic marking is an attribute-related semantic marking, for example, a pen-color semantic marking, a highlighting semantic marking, or another semantic marking associated with the physical appearance of collaboration content.

If the detected semantic marking is 563 attribute related, then a determination 564 may be made as to whether or not the detected semantic marking requires a region identified by an indicator marking. If the detected semantic marking does not 573 require an indicator marking, then the writing-surface record may be updated 574, in accordance with the semantic marking, to reflect the newly added collaboration content, and the reference frame may be updated 576 to reflect the current collaboration writing surface content.

If the detected semantic marking does 565 require an indicator marking, then the changed image may be examined to detect 566 indicator markings. Exemplary indicator markings may include closed curves enclosing newly added or previously existing collaboration content and may be detected 566 according to any detection method or system known in the art. An application region corresponding to an indicator marking may be determined 568. The application region may indicate the region to which the attribute associated with the detected semantic marking is to be applied. In some embodiments of the present invention, the application region may be the entire region contained within the indicator marking. In alternative embodiments of the present invention, the application region may be determined by the minimum bounding box detected for the content within the indicator marking.

The writing-surface record may be updated to 570 reflect the application of the attribute associated with the detected semantic marking to the content within the application region. The reference frame may be updated 572 to reflect the current collaboration surface content.

If the detected semantic marking is not 577 attribute related, then indicator markings may be determined 578 in the changes between the reference frame and the new frame. Application regions associated with the indicator markings may be determined 580, and a process associated with the detected semantic marking may be initiated 582. The initiated process may use the content of the determined application regions in accordance with the definition and requirements of the process. The writing-surface record may be updated 584 to reflect the newly added collaboration content as determined from the changes between the reference frame and the new frame, and the reference frame may be updated 586 to reflect the current collaboration surface content.

Some embodiments of the present invention may be described in relation to

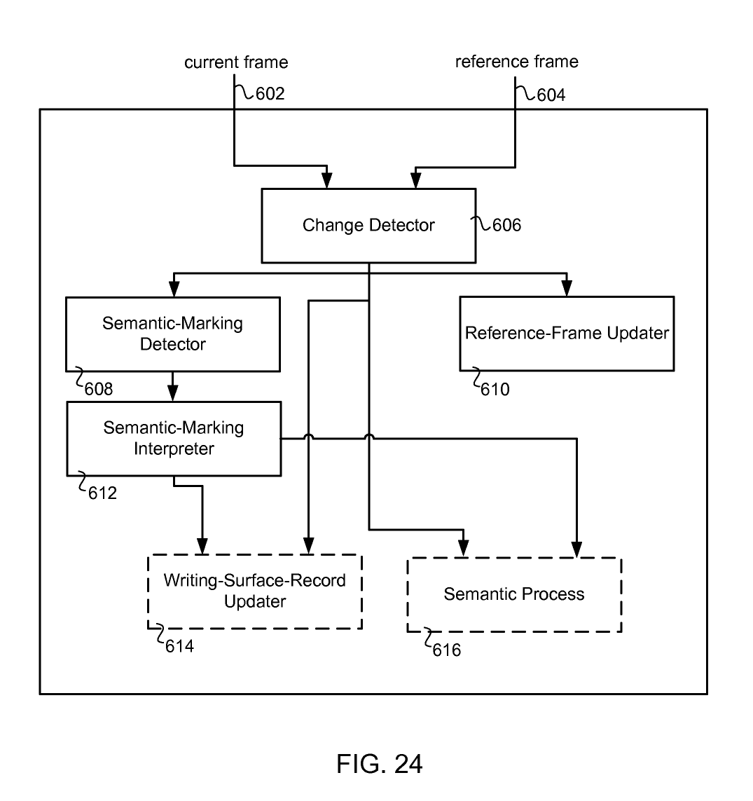

FIG. 24. In these embodiments a current frame 602 associated with a collaboration writing surface and a reference frame 604 associated with the collaboration writing surface may be received by a change detector 606. If the change detector 606 detects significant marking changes between the current frame 602 and the reference frame 604, the change detector 606 may make the detected changes available to a semantic-marking detector 608 and a reference-frame updater 610. The reference-frame updater 610 may update the reference frame to reflect the current content of the collaboration writing surface.

In some embodiments of the present invention, edge information in the current frame and the reference frame may be computed by the change detector 606 to determine changes, also considered updates, to the collaborative writing surface. The gradient of the current frame 602 may be calculated, and the current gradient image may be divided into non-overlapping blocks. For each block, the number of edge pixels for which the gradient magnitude exceeds a threshold, which may be denoted T_{g}, may be calculated. An edge count associated with a block in the current gradient image may be compared to the edge count associated with the corresponding block in a reference gradient image determined from the reference frame 604. If the number of edge pixels in one or more blocks has sufficiently changed, it may be concluded that the current frame includes significant content changes. In some embodiments, to determine if a sufficient number of edge pixels in a block has changed, the ratio of the number edge pixels changed in the block of the current gradient image relative to the corresponding block in the reference gradient image may be compared to a threshold, which may be denoted T_{b}. The block may contain significant content change if the ratio meets a first criterion, for example, is greater than or is greater than or equal to, in relation to the threshold value.

The values of the gradient threshold, T_{g}, and the block edge change detection threshold, T_{b}, may be selected in various ways. In one embodiment of the invention, T_{g} and T_{b} may be set empirically to 800 and 0.25, respectively.

The semantic-marking detector 608 may examine the detected changes to determine if changes were detected in a semantic-significant region of the collaboration writing surface. A semantic-significant region may correspond to a region of the collaboration writing surface reserved for semantic markings.

A semantic-marking interpreter 612 may invoke a process 614, 616 appropriate to the action associated with the detected semantic marking. The semantic-marking interpreter 612 may also obtain additional information required by the process, for example, the semantic-marking interpreter 612 may detect and interpret indicator markings as appropriate to the detected semantic marking. A writing-surface-record updater 614 may be invoked if substantial changes to the collaborative writing surface are detected, and the writing-surface-record updater 614 may update a writing-surface record in accordance with any detected semantic markings. A semantic process 616 associated with a semantic marking may be invoked based on the interpretation of the semantic markings. Exemplary semantic processes may include optical character recognition, tagging of portions of the writing-surface record, routing of portions of the writing-surface record and other processes associated with a collaboration session.

A variety of actions initiated by a detected semantic marking may be envisioned, and the exemplary actions described herein are intended to illustrate and not limit scope of the present invention.

Although the charts and diagrams in the figures described herein may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that software, hardware and/or firmware may be created by one of ordinary skill in the art to carry out the various logical functions described herein.

Some embodiments of the present invention may comprise a computer-program product that is a computer-readable storage medium, and/or media, having instructions stored thereon, and/or therein, that may be used to program a computer to perform any of the features presented herein.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A collaboration system comprising:
a) a change detector for detecting a change between a current frame and a reference frame;
b) a semantic-marking detector for determining if said change corresponds to a semantic marking; and
c) a semantic-marking interpreter for initiating a process associated with said semantic marking when said change corresponds to said semantic marking.

2. The system as described in claim 1, wherein:
a) said current frame is associated with a captured view of a collaborative writing surface captured in response to an occlusion/dis-occlusion event pair; and
b) said reference frame is associated with a captured view of said collaborative writing surface captured prior to said occlusion/dis-occlusion event pair.

3. The system as described in claim 1, wherein said semantic-marking detector comprises a location comparator for comparing the location of said change with a reserved location associated with a semantic attachment.

4. The system as described in claim 3, wherein said semantic-marking detector further comprises a size comparator for comparing the size of said change with a size threshold.

5. The system as described in claim 1, wherein said semantic marking is associated with a text attribute selected from the group consisting of text color, text font, text size, bold text, italicized text, underscored text and text highlighting.

6. The system as described in claim 1, wherein said change detector comprises:
a) a reference-frame edge determiner for determining the edge content in a said reference frame;
b) a current-frame edge determiner for determining the edge content in said current frame; and
c) a comparator for comparing said reference-frame edge content to said current-frame edge content.

7. The system as described in claim 1, wherein said process is a writing-surface-record updating process for updating a writing-surface record associated with said collaborative writing surface in accordance with said semantic marking.

8. The system as described in claim 1, wherein said process is a process selected from the group consisting of a tagging process, a routing process and an optical character recognition process.

9. The system as described in claim 1, wherein said semantic-marking interpreter further comprises an indicator-marking detector for detecting an indicator marking.

10. The system as described in claim 9, wherein said process requires input from a region associated with said indicator marking.

11. The system as described in claim 9, wherein said process updates a region associated with said indicator marking in a writing-surface record associated with said collaborative writing surface in accordance with an attribute associated with said semantic marking.

12. The system as described in claim 1 further comprising:
a) a collaborative writing surface;
b) an occlusion-event detector for detecting an occlusion event associated with said collaborative writing surface; and
c) a dis-occlusion-event detector for detecting a dis-occlusion event associated with said detected occlusion event.

13. The system as described in claim 1 further comprising a reference-frame updater for updating said reference frame in association with said change.

14. A computer-implemented method for forming writing-surface record of a collaborative writing surface, said method comprising:
a) detecting a change between a current frame corresponding to a collaborative writing surface and a reference frame corresponding to said collaborative writing surface;
b) determining if said change corresponds to a semantic marking; and
c) updating a writing-surface record associated with said collaborative writing surface in accordance with said semantic marking when said change corresponds to said semantic marking.

15. The method as described in claim 14, wherein:
a) said current frame is associated with a captured view of said collaborative writing surface captured in response to an occlusion/dis-occlusion event pair; and
b) said reference frame is associated with a captured view of said collaborative writing surface captured prior to said occlusion/dis-occlusion event pair.

16. The method as described in claim 14, wherein said determining comprises comparing the location of said change with a reserved location associated with a semantic attachment.

17. The method as described in claim 14, wherein said determining comprises comparing the size of said change with a size threshold.

18. The method as described in claim 14, wherein said semantic marking is associated with a text attribute selected from the group consisting of text color, text font, text size, bold text, italicized text, underscored text and text highlighting.

19. The method as described in claim 14, wherein said detecting comprises:
a) determining the edge content in a said reference frame;
b) determining the edge content in said current frame; and
c) comparing said reference-frame edge content to said current-frame edge content.

20. A computer-implemented method for initiating a process in conjunction with a collaboration session, said method comprising:
a) detecting a change between a current frame associated with a collaborative writing surface and a reference frame associated with said collaborative writing surface;
b) determining if said change corresponds to a semantic marking; and
c) initiating a process associated with said semantic marking when said change corresponds to said semantic marking.

21. The method as described in claim 20, wherein:
a) said current frame is associated with a captured view of said collaborative writing surface captured in response to an occlusion/dis-occlusion event pair; and
b) said reference frame is associated with a captured view of said collaborative writing surface captured prior to said occlusion/dis-occlusion event pair.

22. The method as described in claim 20, wherein said determining comprises comparing the location of said change with a reserved location associated with a semantic attachment.

23. The method as described in claim 20, wherein said determining comprises comparing the size of said change with a size threshold.

24. The method as described in claim 20, wherein said semantic marking is associated with a text attribute selected from the group consisting of text color, text font, text size, bold text, italicized text, underscored text and text highlighting.

25. The method as described in claim 20, wherein said detecting comprises:
a) determining the edge content in a said reference frame;
b) determining the edge content in said current frame; and
c) comparing said reference-frame edge content to said current-frame edge content.

26. The method as described in claim 20, wherein said process is a writing-surface-record updating process for updating a writing-surface record associated with said collaborative writing surface in accordance with said semantic marking.

27. The method as described in claim 20, wherein said process is a process selected from the group consisting of a tagging process, a routing process and an optical character recognition process.

28. The method as described in claim 20, further comprising detecting an indicator marking.

29. The method as described in claim 28, wherein said process requires input from a region associated with said indicator marking.

30. The method as described in claim 28, wherein said process updates a region associated with said indicator marking in a writing-surface record associated with said collaborative writing surface in accordance with an attribute associated with said semantic marking.

31. The method as described in claim 20 further comprising updating said reference frame in association with said change.
